(19) United States
(12) Patent Application Publication
(10) Pub. No.: US 2010/0118220 A1
(43) Pub. Date: May 13, 2010

(54) DISPLAY DEVICE

(75) Inventors: Yong-Kyu JANG, Hwasung-si (KR); Sang-Jin PAK, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO. LTD., Suwon-si (KR)

(21) Appl. No.: 12/434,191

(22) Filed: May 1, 2009

(30) Foreign Application Priority Data
Nov. 9, 2008 (KR) 10-2008-0090018

(51) Int. Cl. G02F 1/1335; G02F 1/1343

(52) U.S. Cl. 349/39; 349/114

(57) ABSTRACT

A display device, including a lower substrate; an upper substrate disposed opposite to the lower substrate; a liquid crystal layer interposed between the lower substrate and the upper substrate; and a plurality of pixels, each of the pixels including at least one reflective electrode and at least one transparent electrode; the reflective electrodes and the transparent electrodes disposed on the lower substrate and electrically insulated from each other, wherein a reflective region corresponds to a region of the reflective electrodes and a transmissive region corresponds to a region of the transparent electrodes, and when a display luminance in the reflective region and the transmissive region is increased, a first voltage applied to the liquid crystal layer in one of the reflective region and the transmissive region is increased and a second voltage applied to the liquid crystal layer in the other of the reflective region and the transmissive region is decreased.

This application claims priority to Korean Patent Application No. 10-2008-0090018, filed on Sep. 11, 2008, and all the benefits accruing therefrom under 35 U.S.C. §119, the contents of which in its entirety are herein incorporated by reference.

### BACKGROUND OF THE INVENTION

(a) Field of the Invention

This disclosure relates to a display device.

(b) Description of the Related Art

A liquid crystal display (“LCD”) is a flat display device. The liquid crystal display includes two substrates, each having an electrode, and a liquid crystal layer interposed between the two substrates. In the liquid crystal display, an orientation of liquid crystal molecules disposed in the liquid crystal layer is controlled by selecting a voltage applied to the electrodes, thereby selecting a transmittance of light, which passes through the liquid crystal layer. The transmittance is determined by a phase retardation, which is generated due to an optical characteristic of a liquid crystal material when the light passes through the liquid crystal layer. The phase retardation is determined by selecting a refractive anisotropy of the liquid crystal material and a gap between the two substrates.

A liquid crystal display can include two substrates, each having electrodes and thin film transistors (“TFTs”) which switch voltages applied to the electrodes. In the liquid crystal display, the thin film transistors can be disposed on one of the two substrates.

The liquid crystal display may be divided into a transmissive liquid crystal display, which displays an image by transmitting light emitted from a backlight, which is a light source for illumination of a liquid crystal layer, and a reflective liquid crystal display, which displays an image by reflecting external light, such as ambient light disposed on a liquid crystal layer using a reflective electrode of the liquid crystal display. In recent years, a transflective liquid crystal display, which can operate in both a reflective mode and a transmissive mode, has been developed.

In order to display the same gray representation in a reflective mode and a transmissive mode, the transflective liquid crystal display has the following restrictive elements.

When a white color is displayed in a reflective mode, a quarter wave film, hereinafter termed a λ/4 phase difference film, is desirably disposed on each of an upper panel and a lower panel to display a white color in a transmissive mode. This allows the same display to be performed in the reflective mode and the transmissive mode, but increases manufacturing cost and can causes side light leakage.

Further, in an in-plane switching (“IPS”) liquid crystal display, which displays an image using a horizontal electric field, a quarter wave (“λ/4”) phase difference is desirably provided to only a reflective region, but this can be difficult. Accordingly, it is difficult to manufacture a transflective liquid crystal display.

It is therefore desirable to have a transflective liquid crystal display without a λ/4 phase difference film.

### BRIEF SUMMARY OF THE INVENTION

The above described and other drawbacks are alleviated by a transflective liquid crystal display without λ/4 phase difference film and having a horizontal electric field.

In a liquid crystal display according to an exemplary embodiment, when a first voltage applied to liquid crystal located in a reflective region increases or decreases as display luminance increases, a second voltage applied to liquid crystal located in a transmissive region decreases or increases, respectively, thus the second voltage changes in a manner contrary to a change in the reflective region.

Disclosed is a display device including a lower substrate; an upper substrate disposed opposite to the lower substrate; a liquid crystal layer interposed between the lower substrate and the upper substrate; a plurality of pixels, each of the pixels including at least one reflective electrode and at least one transparent electrode; the reflective electrodes and the transparent electrodes disposed on the lower substrate and electrically insulated from each other, wherein a reflective region is a region corresponds to a region of the reflective electrodes and a transmissive region corresponds to a region of the transparent electrodes, and when a display luminance in the reflective region and the transmissive region is increased, a first voltage applied to the liquid crystal layer in one of the reflective region and the transmissive region is increased and a second voltage applied to the liquid crystal layer in the other of the reflective region and the transmissive region is decreased.

In an embodiment, when a white color displayed in the reflective region, a white color is displayed in the transmissive region, and when a black color is displayed in the reflective region, a black color is displayed in the transmissive region.

When the display luminance increases, a first voltage applied to the liquid crystal layer in the transmissive region may increase, and a second voltage applied to the liquid crystal layer in the reflective region may decrease.

The display device may further include first signal lines disposed on the lower substrate and crossing regions between the reflecting electrodes and the transparent electrodes; second signal lines disposed on the lower substrate substantially parallel to gate lines and crossing regions between adjacent pixels in a vertical direction; data lines disposed on the lower substrate and crossing the first signal lines and the second signal lines, the data lines, the first signal lines, and the second signal lines electrically insulated from each other; first thin film transistors electrically connected to the transparent electrodes; and second thin film transistors electrically connected to the reflecting electrodes. One of the first signal lines and the second signal lines may be the gate lines and the other of the first signal lines and the second signal lines may be storage electrode lines. Adjacent first and second thin film transistors may be electrically connected to a same gate line and a same data line. The storage electrode lines may overlap the reflecting electrodes of adjacent pixels and the transparent electrodes of other pixels.

A plurality of voltages may be sequentially applied to the storage electrode lines in one direction such that a high voltage and a low voltage are alternately applied to the storage electrode lines, the high voltage being greater than the low voltage.

The high voltage or the low voltage applied to the storage electrode lines may be changed to a gate-off signal, wherein the high voltage or the low voltage may be applied after a gate signal is applied to thin film transistors electrically connected to the storage electrode lines.

An area where the storage electrode lines and the reflective electrodes overlap may be different from an area where the storage electrode lines and the transparent electrodes overlap.

An area where the storage electrode lines and the transparent electrodes overlap may be equal to or larger than an area where the storage electrode lines and the reflective electrodes overlap.

A kick-back voltage may be selected by selecting a parasitic capacity of the reflective region and a parasitic capacity of the transmissive region.

The display device may further include gate lines disposed on the lower substrate; data lines disposed on the lower substrate and crossing the gate lines, wherein the data lines and the gate lines are electrically insulated from each other; first thin film transistors electrically connected to the transparent electrodes; and second thin film transistors electrically connected to the reflecting electrodes, wherein the first and second thin film transistors are disposed in a pixel and may be electrically connected to the same gate line and different data lines.

Two or more data lines may be disposed for each pixel.

A range of voltages applied to the reflecting electrodes may be the same as a range of voltages applied to the transparent electrodes.

A thickness of the liquid crystal layer disposed in the reflective region may be less than a thickness of the liquid crystal layer disposed in the transmissive region.

The display device may further include color filters disposed on the upper and lower substrates of the display device, wherein a thickness of the color filter in the reflective region may be less than a thickness of the color filter in the transmissive region.

A range of voltages applied to the reflecting electrodes may be different from a range of voltages applied to the transparent electrodes.

A range of voltages applied to the reflecting electrodes may be smaller than a range of voltages applied to the transparent electrodes.

A difference between a thickness of the liquid crystal layer disposed in the reflective region and a thickness of the liquid crystal layer disposed in the transmissive region may be within about 30 percent (“%”) of the thickness of the liquid crystal layer disposed in the transmissive region.

The display device may further include color filters disposed on at least one of the upper substrate and the lower substrate. A thickness of the color filter in the reflective region may be less than a thickness of the color filter in the transmissive region.

A range of voltages applied to the reflecting electrodes and the transparent electrodes may be selected to include a range of voltages wherein transmittance increases or decreases when an increased or decreased voltage is sequentially applied to the reflecting electrodes and the transparent electrodes.

The display device may further include a common electrode disposed on one of the lower substrate and the upper substrate and applied with a common voltage.

The common electrode may be disposed on the lower substrate, and at least one of the reflecting electrodes, the transparent electrodes, and the common electrode may include two or more linear electrodes in a pixel.

Polarizers may be disposed on outer surfaces of the lower substrate and the upper substrate, respectively.

In the transflective liquid crystal display according to an exemplary embodiment, since a λ/4 phase difference film is desirably not used, a manufacturing cost is reduced and a thickness of the display device is also reduced. Further, it is possible to reduce or substantially eliminate side light leakage due to a λ/4 phase difference film. Also, it is possible to manufacture a transflective liquid crystal display using a horizontal electric field.

### BRIEF DESCRIPTION OF THE DRAWINGS

The disclosed subject matter is particularly pointed out and distinctly claimed in the claims at the conclusion of the specification. The foregoing and other objects, features, and advantages of the disclosed embodiments are apparent from the following detailed description taken in conjunction with the accompanying drawings in which:

FIG. 1 is a block diagram of an exemplary embodiment of a liquid crystal display;

FIG. 2 is an equivalent circuit diagram of an exemplary embodiment of a pixel in an exemplary embodiment of a liquid crystal display;

FIG. 3 is a circuit diagram of an exemplary embodiment of adjacent pixels in an exemplary embodiment of a liquid crystal panel assembly;

FIG. 4 is a timing chart of an exemplary embodiment of a signal, which is applied in accordance with an exemplary embodiment;

FIG. 5 is a graph illustrating a change in a voltage of an exemplary embodiment of a pixel on the basis of the timing chart of FIG. 4;

FIG. 6 is a graph illustrating transmittance with respect to a voltage in an exemplary embodiment of a transmissive region;

FIG. 7 is a graph illustrating transmittance with respect to a voltage in an exemplary embodiment of a reflective region;

FIG. 8 is a graph illustrating transmittance with respect to a voltage in an exemplary embodiment of a reflective region;

FIG. 9 is a cross-sectional view of an exemplary embodiment of a transflective liquid crystal display;

FIG. 10 is a block diagram of an exemplary embodiment a liquid crystal display;

FIG. 11 is an equivalent circuit diagram of an exemplary embodiment of a pixel in an exemplary embodiment of a liquid crystal display; and

FIG. 12 is an equivalent circuit diagram of an exemplary embodiment of a pixel in an exemplary embodiment of a liquid crystal display.

The detailed description explains the disclosed embodiments, together with advantages and features, by way of example with reference to the drawings.

### DETAILED DESCRIPTION OF THE INVENTION

The following detailed description includes exemplary embodiments, which are shown and described by way of illustration. As those skilled in the art would realize, the disclosed embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Aspects, advantages, and features of the invention and methods of accomplishing the same may be understood more readily by reference to the following detailed description of preferred embodiments and the accompanying drawings. The invention may, however, may be embodied in many different forms, and should not be construed as being limited to the embodiments set forth herein. Rather, these embodiments are provided so that this disclosure will be thorough and complete and will fully convey the concept of the invention to those skilled in the art, and the invention will only be defined by the appended claims.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer, or section from another region, layer or section. Thus, a first element, component, region, layer, or section discussed below could be termed a second element, component, region, layer, or section without departing from the teachings of the invention.

Spatially relative terms, such as “below”, “lower”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “lower” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, the invention will be described in detail with reference to the accompanying drawings. However, the aspects, features, and advantages of the invention are not restricted to the ones set forth herein. The above and other aspects, features and advantages of the invention will become more apparent to one of ordinary skill in the art to which the invention pertains by referencing a detailed description of the invention given below.

A driving device of a liquid crystal display, which is an example of a driving device of a display device, is described in detail with reference to the accompanying drawings.

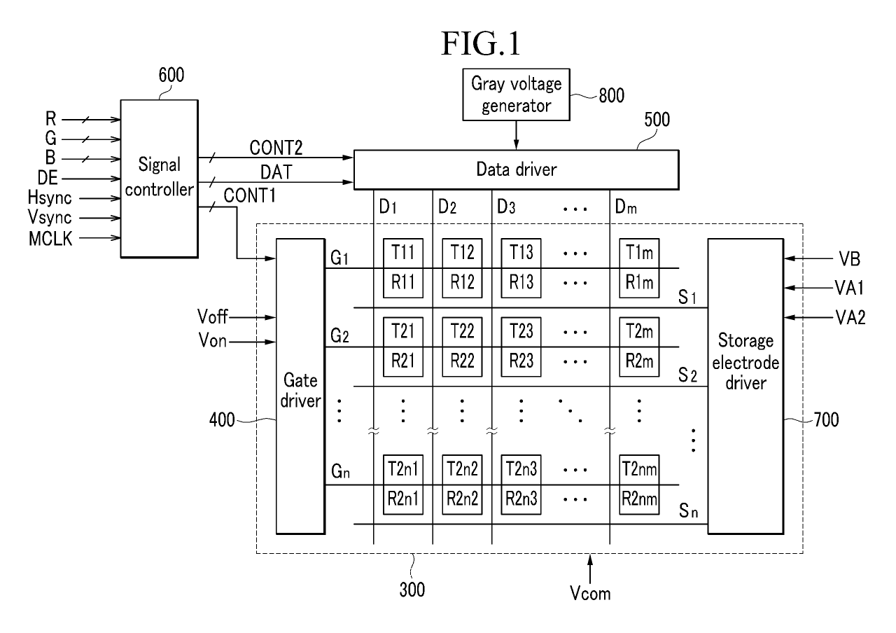

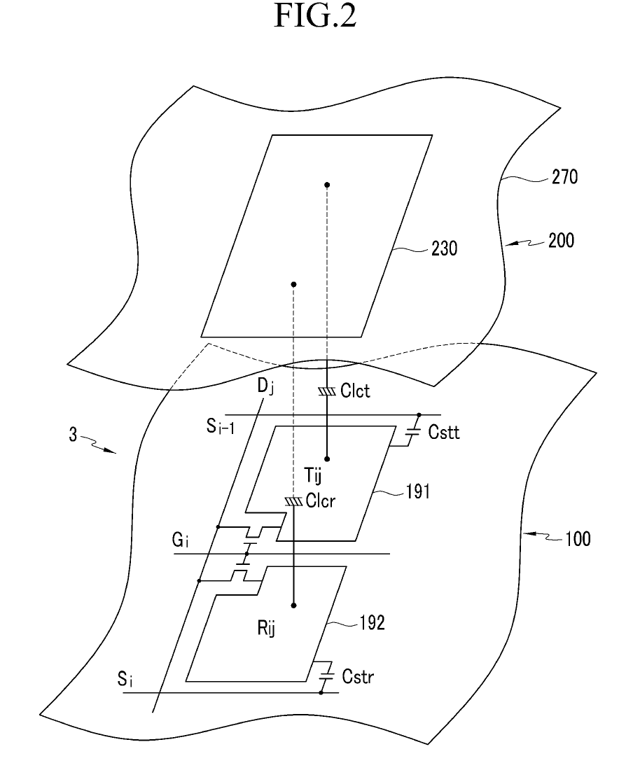

First, referring to FIGS. 1 and 2, a liquid crystal display according to an exemplary embodiment is described in detail.

FIG. 1 is a block diagram of an exemplary embodiment a liquid crystal display, and FIG. 2 is an equivalent circuit diagram of an exemplary embodiment of a pixel in an exemplary embodiment of a liquid crystal display.

As shown in FIG. 1, the liquid crystal display, according to an exemplary embodiment, includes a liquid crystal panel assembly 300, a data driver 500 electrically connected to the liquid crystal panel assembly 300, a gray voltage generator 800 electrically connected to the data driver 500, and a signal controller 600 for controlling and electrically connected to the above-described components.

As shown in the equivalent circuit diagram included in FIG. 1, the liquid crystal panel assembly 300 includes a plurality of signal lines, which include a plurality of gate lines G1 to Gn, a plurality of data lines D1 to Dm, and a plurality of storage electrode lines S1 to Sn. A plurality of pixels PX are electrically connected to the signal lines and arranged substantially in a matrix. A gate driver 400 is electrically connected to and supplies signals to the gate lines G1 to Gn, and a storage electrode line driver 700 is electrically connected to and supplies signals to the storage electrode lines S1 to Sn.

As shown in FIG. 2, the liquid crystal panel assembly 300 includes lower and upper panels 100 and 200, respectively, which are disposed opposite to each other, and a liquid crystal layer 3, which is interposed therebetween.

The gate lines G1 to Gn extend substantially in a row direction so as to be parallel to each other, and the data lines D1 to Dm extend substantially in a column direction so as to be parallel to each other. The storage electrode lines S1 to Sn extend in a direction which is substantially parallel to the gate lines G1 to Gn.

Each of the pixels PX, is connected to an i-th (i=1, 2, . . . , n) gate line Gi and a j-th (j=1, 2, . . . , m) data line Dj, and includes a switching element, is electrically connected to the corresponding signal lines, which include a corresponding gate line Gi and a corresponding data line Dj, and a liquid crystal capacitor Clc and a storage capacitor Cst, which are connected to the switching element.

Each of the pixels PX includes a transmissive region Tij and a reflective region Rij, thus comprise a transparent pixel electrode 191 and a reflective pixel electrode 192, and the regions thereof are divided by the gate lines G1 to Gn. In an exemplary embodiment, shown in FIG. 2, the transmissive region Tij is located at an upper side of the gate line Gi, and the reflective region Rij is located at a lower side of the gate line Gi.

In an embodiment, the second storage electrode line Si is disposed to cross a region between rows of pixels connected to the i-th gate line Gi and the (i+1)-th gate line Gi+1. The connectivity between the pixels PX, the gate lines G1 to Gn, and the storage electrode lines S1 to Sn, is described below.

A switching element are disposed in the transmissive region Tij and the reflective region Rij, or disposed so as to be integral with each of the transmissive and reflective regions. The switching element is a three-terminal element, such as a thin film transistor, which is disposed on the lower panel 100. A control terminal of the switching element is electrically connected to a corresponding gate line Gi, an input terminal thereof is electrically connected to a corresponding data line Dj, and an output terminal thereof is electrically connected to corresponding transmissive and reflective liquid crystal capacitors Clct and Clcr, respectively, of the transmissive region Tij and the reflective region Rij, respectively, and transmissive and reflective storage capacitors Cstt and Cstr, respectively, of the transmissive region Tij and the reflective region Rij.

The transmissive and reflective liquid crystal capacitors Clct and Clcr have as terminals transparent and reflective pixel electrodes 191 and 192, respectively, of the lower panel 100, and a common electrode 270 of the upper panel 200. The transparent pixel electrode 191 can be transparent, and the reflective pixel electrode 191 can be reflective. The liquid crystal layer 3, disposed between the transparent and reflective pixel electrodes 191 or 192 and the common electrode 270, functions as a dielectric material. The transparent and reflective pixel electrodes 191 and 192 are electrically connected to the switching element, and the common electrode 270 is disposed on substantially an entire surface of the upper panel 200 and is supplied with a common voltage Vcom. The common voltage may be a DC voltage, which has a selected value. In an embodiment, the transparent pixel electrode 191 can be a transparent electrode, and the reflective pixel electrode 192 can be a reflecting electrode. The transparent pixel electrode 191, which can be transparent, is disposed in the transmissive region Tij and the reflective pixel electrode 192, which can be reflecting, is disposed in the reflective region Rij.

In another embodiment, the common electrode 270 may be disposed on the lower panel 100. In an embodiment, at least one of the transparent and reflective pixel electrodes 191 and 192, and the common electrode 270, may be disposed to have a rectilinear or bar shape.

The transmissive and reflective storage capacitors Cstt and Cstr, which serve as auxiliary members of the transmissive and reflective liquid crystal capacitors Clct and Clcr, are disposed overlapping first and second storage electrode lines Si-1 and Sit respectively, which are disposed on the lower panel 100, and the transparent and reflective pixel electrodes 191 and 192, respectively, with an insulator interposed therebetween. Each of the first and second storage electrode lines Si-1 and Si has a low level voltage and a high level voltage, and is applied with a storage voltage having a level, which can change for every selected period. In an embodiment, the low level voltage may be about 0.1 volts, specifically 0 volts (“V”), and the high level voltage may be about 7 V, specifically about 5 V, more specifically about 3 V, and the selected period may be one frame.

In an embodiment, in order to implement color display, each of the pixels PX displays a primary color (spatial division), or displays the primary colors with the passage of time (temporal division), which causes desired colors to be recognized by spatial and temporal sums of the primary colors. The primary colors may include three primary colors, such as red, green, and blue. Disclosed in FIG. 2 is an embodiment comprising spatial division, wherein each of the pixels PX has a color filter 230 for displaying one of the primary colors in a region of the upper panel 200, which corresponds to the transparent and reflective pixel electrodes 191 and 192.

At least one polarizer (not shown) for polarizing light is disposed on an outer surface of the liquid crystal panel assembly 300.

Referring to FIG. 1 again, the gray voltage generator 800 generates two gray voltage groups (or reference gray voltage groups) related to a transmittance of each of the pixels PX. One of the two gray voltage groups has a positive value with respect to the common voltage Vcom, and the other has a negative value with respect to the common voltage Vcom.

The gate driver 400 is electrically connected to the gate lines G1 to Gn of the liquid crystal panel assembly 300, and applies gate signals, each comprising a combination of a gate-on voltage Von and a gate-off voltage Voff, to the gate lines G1 to Gn. In an embodiment, the gate driver 400 is disposed by the same process as the switching element of the pixel, and they are integrated. In an embodiment, the gate driver 400 may be directly mounted on the liquid crystal panel assembly 300 in a form of at least one integrated circuit (“IC”) chip, mounted on a flexible printed circuit film (not shown) to be attached to the liquid crystal panel assembly 300 in a form of a tape carrier package (“TCP”), or mounted on a separate printed circuit board (“PCB”) (not shown).

The data driver 500 is electrically connected to the data lines D1 to Dm of the liquid crystal panel assembly 300, and it selects the gray voltages from the gray voltage generator 800 and applies the selected gray voltages to the data lines D1 to Dm as the data signals. In an embodiment, the gray voltage generator 800 does not provide all the gray voltages but provides only a selected number of reference gray voltages and the data driver 500 divides the reference gray voltages to generate gray voltages with respect to all grays and selects a data signal from the gray voltages.

The storage electrode line driver 700 is electrically connected to the storage electrode lines S1 to Sn of the liquid crystal panel assembly 300, and applies the storage voltage to each of the storage electrode lines S1 to Sn. The storage electrode line driver 700 can be disposed using the same process as the switching element of the pixel, and they can be integrated. In an embodiment, the storage electrode line driver 700 may be directly mounted on the liquid crystal panel assembly 300 in a form of an IC chip, mounted on a flexible printed circuit film (not shown) to be disposed on the liquid crystal panel assembly 300 in a form of a TCP, or mounted on a separate printed circuit board (not shown). The signal controller 600 controls the gate driver 400, the storage electrode line driver 700, and the data driver 500.

Each of the driving devices, including the data driver 500, signal controller 600, the storage electrode line driver 700, and the data driver 800 may be directly mounted on the liquid crystal panel assembly 300 in a form of at least one IC chip, mounted on a flexible printed circuit film (not shown) to be attached to the liquid crystal panel assembly 300 in a form of a TCP, or mounted on a separate PCB (not shown). Alternatively, the driving devices may be integrated with the liquid crystal panel assembly 300 together with the signal lines, including the gate lines G1 to Gn, the data lines D1 to Dm, and the storage lines S1 to Sn, and the thin film transistor switching elements. In addition, the driving devices may be integrated into a single chip. In an embodiment, at least one of the driving devices or at least one circuit element, which can comprise the data driver 500, signal controller 600, the storage electrode line driver 700, and the data driver 800, may be disposed outside the single chip.

The operation of the liquid crystal display is hereinafter described in detail.

The signal controller 600 receives input image signals R, G, and B, and input control signals for controlling display thereof from an external graphics controller (not shown). In an embodiment, the input control signals include a vertical synchronizing signal Vsync, a horizontal synchronizing signal Hsync, a main clock signal MCLK, and a data enable signal DE.

The signal controller 600 processes the input image signals R, G, and B on the basis of the input control signals according to the operation conditions of the liquid crystal panel assembly 300, and generates a gate control signal CONT1 and a data control signal CONT2. Then, the signal controller 600 transmits the gate control signal CONT1 to the gate driver 400, and transmits the data control signal CONT2 and the processed image signal DAT to the data driver 500.

The gate control signal CONT1 includes a scanning start signal STV, indicating a start of scanning, and at least one clock signal for controlling an output cycle of the gate-on voltage Von. The gate control signal CONT1 may further include an output enable signal OE for defining the duration of the gate-on voltage Von.

The data control signal CONT2 includes a horizontal synchronization start signal STH, indicating a start of transmission of image signals to one row of pixels PX, a load signal LOAD instructing application of data signals to the data lines D1 to Dm, and a data clock signal HCLK. The data control signal CONT2 may further include an inversion signal RVS for inverting the voltage polarity of the data signal with respect to the common voltage Vcom. Hereinafter, a voltage polarity of a data signal with respect to a common voltage is simply referred to as a polarity of a data signal.

The data driver 500 receives the digital image signals DAT for a row of pixels PX according to the data control signal CONT2 from the signal controller 600, and selects the gray voltages corresponding to the digital image signals DAT. Then, the data driver 500 converts the digital image signals DAT into the analog data signals, and applies the converted analog data signals to the data lines D1 to Dm.

The gate driver 400 applies the gate-on voltage Von to the gate lines G1 to Gn according to the gate control signal CONT1 from the signal controller 600 and turns on the switching elements, which are respectively electrically connected to the gate lines G1 to Gn. Then, the data signals applied to the data lines D1 to Dm are applied to the pixels PX through the turned-on switching elements.

On a basis of first to third external control signals VB, VA1, and VA2, the storage electrode line driver 700 sequentially applies a storage voltage having a selected level to the storage electrode lines S1 to Sn, and changes a voltage applied to the transparent and reflective pixel electrodes 191 and 192, wherein the voltage can be a pixel electrode voltage. In an embodiment, the storage voltage is applied when a charging operation of the pixels is completed, thus in an embodiment the gate signal applied to the gate lines G1 to Gn changes from the gate-on voltage Von to the gate-off voltage Voff.

As described above, a difference between the pixel electrode voltage applied to each of the pixels PX and the common voltage Vcom becomes a charging voltage of the transmissive and reflective liquid crystal capacitors Clct and Clcr, thus can be the pixel voltage. The arrangement of the liquid crystal molecules varies according to the magnitude of the pixel voltage such that a polarization of light passing through the liquid crystal layer 3 changes. The change of the polarization causes a change in transmittance of the light by the polarizer, which is attached to the liquid crystal panel assembly 300.

This process is repeated for every horizontal period, which is also called “1H” and is equal to one cycle of the horizontal synchronizing signal Hsync and the data enable signal DE. Then, the gate-on voltage Von is sequentially applied to the gate lines G1 to Gn and the data signals are applied to the pixels PX. Accordingly, an image for one frame is displayed.

When a second frame starts after a first frame is completed, a state of the inversion signal RVS applied to the data driver 500 is controlled such that a polarity of the data signal applied to each of the pixels PX is inverted with respect to a polarity of the previous frame. This can be termed frame inversion. In one frame a polarity of a data signal in a data line may be inverted and polarities of data signals, which are applied to a row of pixels, can be the same according to the characteristics of the inversion signal RVS. This can be termed row inversion.

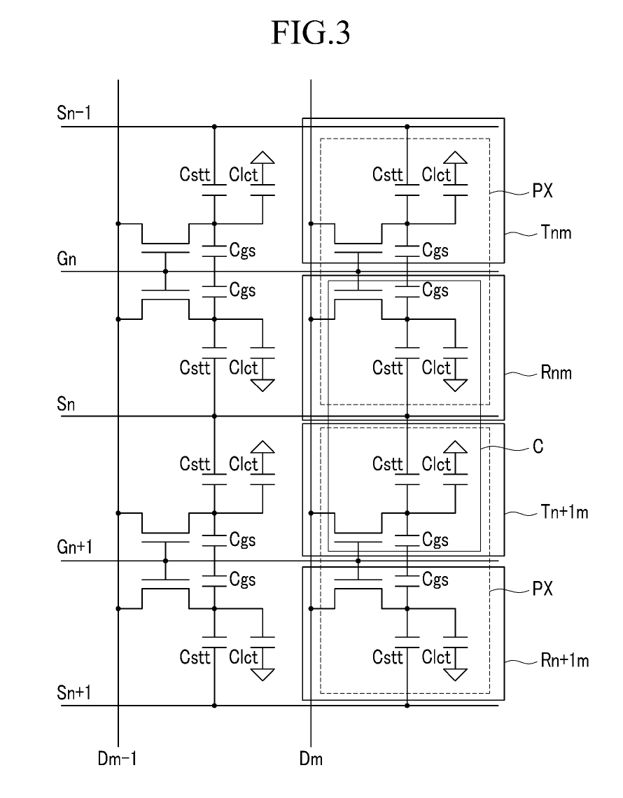

A change in voltage of the transmissive region and the reflective region between adjacent pixels is described in detail with reference to FIGS. 3 to 5.

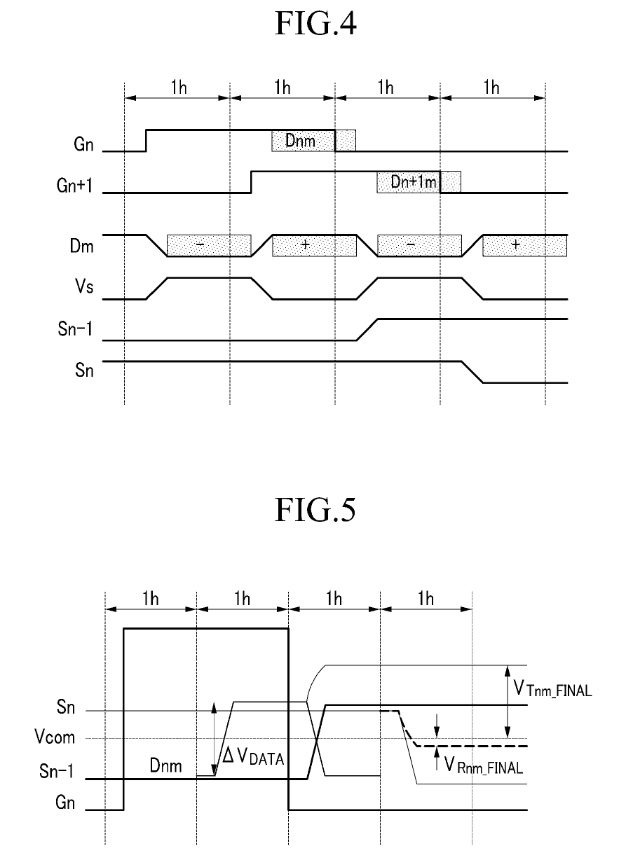

FIG. 3 is a circuit diagram showing an exemplary embodiment of adjacent pixels of a liquid crystal panel assembly, FIG. 4 is a timing chart showing an exemplary embodiment of a signal, which is applied in accordance with an exemplary embodiment, and FIG. 5 is a graph illustrating a change in a voltage of an exemplary embodiment of a pixel on the basis of the timing chart of FIG. 4.

As shown in FIG. 3, the pixels PX can be disposed in a vertical direction on the basis of a storage electrode line Sn in the liquid crystal panel assembly 300, according to the exemplary embodiment. Each of the pixels PX has a transmissive region, such as first and second transmissive regions Tnm and Tn+1m, and a reflective region, such as first and second reflective regions Rnm and Rn+1m, which are separated by a gate line, such as first and second gate lines Gn and Gn+1. In an embodiment, each of the pixels PX has a transmissive region and reflective region, which are electrically connected to the same gate line, and the transmissive region of a pixel is electrically connected to a reflective region of an adjacent pixel through the storage electrode line.

FIGS. 2 and 3 show a structure in which a pixel comprises a reflecting electrode and a transmissive electrode. In an embodiment, the transmissive electrode is transparent. In another embodiment, a pixel can comprise one or two or more reflecting electrodes and one or two or more transmissive electrodes.

In FIGS. 2 and 3, the gate lines pass though regions between each of the transmissive electrodes and the reflecting electrodes, and the storage electrode lines pass through regions between adjacent pixels. In an embodiment, the storage electrode lines may pass through regions between the transmissive electrodes and the reflecting electrodes, and the gate lines may pass through regions between adjacent pixels.

As shown in FIG. 4, a gate-on signal is sequentially applied to first and second gate lines Gn and Gn+1. In FIG. 4, a dotted line indicates a time of 1 H, and the gate-on signal may be applied to the corresponding gate line before an interval of time of 1 H during which an on-signal is applied to the corresponding gate line.

In an embodiment, the data voltage is applied along a data line Dm at a gate-on time. The applied data voltage is applied to the transparent and reflective pixel electrodes 191 and 192 through a turned-on transistor, and the transmissive and reflective liquid crystal capacitors Clct and Clcr are charged.

Further, signals are sequentially applied to third and fourth storage electrode lines Sn-1 and Sn in synchronization with a storage electrode signal Vs, and a high voltage and a low voltage are applied on the basis of the common voltage Vcom. The high voltage or the low voltage is applied to the third and fourth storage electrode lines Sn-1 and Sn after a turn-off voltage is applied to the gate lines of the pixels electrically connected to the third and fourth storage electrode lines Sn-1 and Sn, and the magnitude of the high voltage or the low voltage may be changed in accordance with the exemplary embodiment.

In an embodiment wherein the above-described signal is applied in the structure shown in FIG. 3, the signal is applied as follows and voltage changes are as described in the graph of FIG. 5. In an embodiment the dotted lines shown in FIGS. 4 and 5 correspond to each other, and a change in voltage when a signal is applied is as follows.

First, a gate-on signal is applied through the first gate line Gn. As a result, a transistor, which is electrically connected to the first gate line Gn, is turned on. Since the transistor of the first transmissive region Tnm and the transistor of the first reflective region Rnm are electrically connected to the first gate line Gn, both of the foregoing transistors are turned on. At this time, the data voltage + is applied to the transparent and reflective pixel electrodes 191 and 192 through the turned-on transistors, and the transmissive and reflective liquid crystal capacitors Clct and Clcr are charged. Since the same data voltage + is applied to each of the transparent and reflective pixel electrodes 191 and 192, the transmissive and reflective liquid crystal capacitors Clct and Clcr are charged to substantially the same state of charge.

The transmissive liquid crystal capacitor Clct of the first transmissive region Tnm and the reflective liquid crystal capacitor Clcr of the first reflective region Rnm are electrically connected to the third and fourth storage electrode lines Sn-1 and Sn. Since the third and fourth storage electrode lines Sn-1 and Sn apply different voltages with different timing, the transmissive and reflective liquid crystal capacitors Clct and Clcr, which are charged substantially a same amount, change to have different states of charge, respectively.

In an embodiment, if the high voltage is applied to the third storage electrode line Sn-1 on the basis of the common voltage Vcom, the state of charge of the transmissive liquid crystal capacitor Clct of the first transmissive region Tnm, which is electrically connected to the third storage electrode line Sn-1, increases. As a result, a voltage, which is applied to the transparent pixel electrode 191, increases. The increased voltage is a final voltage in the transparent electrode.

Then, if the low voltage is applied to the fourth storage electrode line Sn on the basis of the common voltage Vcom, the charged amount of the reflective liquid crystal capacitor Clcr of the first reflective region Rnm, which is electrically connected to the fourth storage electrode line Sn, decreases. As a result, a voltage, which is applied to the reflective pixel electrode 192, decreases. The decreased voltage is called a final voltage in the reflecting electrode.

As a result, as shown in FIG. 5, even though a same data voltage is first applied to a same pixel, different voltages are charged in the first transmissive region Tnm and the first reflective region Rnm, changing an inclination of liquid crystals, which are interposed between the transmissive region and the reflecting region.

As described above, when the voltage is applied to the storage electrode lines to increase or decrease the voltage of the pixels, the voltage, which is applied to the transparent and reflective pixel electrodes 191 and 192, can be represented by Equation 1:

$${Vp}^{′} = Vd \pm Δ = Vd \pm \frac{Cst}{Clc + Cst + Cgs} \times ( Vh - Vl ) . \qquad Equation 1$$

In an embodiment, Vp′ denotes a voltage, which is applied to the transparent and reflective pixel electrodes 191 and 192, Vd denotes a data voltage, which is applied through a data line, Δ denotes an increase or decrease voltage, Cst denotes a capacity of a storage capacitor, Clc denotes a capacity of a liquid crystal capacitor, Cgs denotes a parasitic capacity between a gate line and a source electrode, Vh denotes a high voltage applied to the storage electrode line, and Vl denotes a low voltage applied to an organic electrode line. In an embodiment, the capacity Cst of the storage capacitor is determined by an area where at least one of the transparent pixel electrode and the reflective pixel electrode and the storage electrode line overlap, and if an overlapping area is increased, the capacity Cst increases.

Referring to Equation 1, in the exemplary embodiments shown in FIGS. 1 to 3, in order to change the increase or decrease voltage Δ, a value of the capacity of the storage capacitor Cst or a ratio of the high voltage to a low voltage (Vh/Vl) is selected. In an embodiment, a parasitic capacity Cgs between the gate line and the source electrode is also selected. Thus, if a value of the storage capacitor Cst changes, kick-back voltages change. In an embodiment, the parasitic capacity Cgs is selected such that the kick-back voltages are the same or similar to each other in the transmissive region and the reflective region. As a result, it is possible to reduce or substantially prevent a flicker from being generated due to differences between the kick-back voltages in the reflective region and the transmissive region, respectively.

If a final voltage in the transparent electrode and a final voltage in the reflecting electrode are selected to satisfy the following relationship, it is possible to form a transflective liquid crystal display.

In the first reflective region Rnm, externally incident light is incident on the reflective pixel electrode 192 and a phase thereof is changed by 180 degrees. Thus, if an electric filed is applied to display a white color in the transmissive region, a black color is displayed in the first reflective region Rnm by the same electric field. The same display is desirably performed in the transmissive region and the reflective region. For this purpose, according to an exemplary embodiment, when a gray increases, a change in a voltage of the first reflective region Rnm is allowed to be opposite to a change in a voltage of the first transparent region Tnm. Thus, in an embodiment where the voltage applied to the transparent pixel electrode 191 increases as the gray in the first transmissive region Tnm increases, the voltage, which is applied to the reflective pixel electrode 192 decreases as the gray increases in the first reflective region Rnm. Also, in the opposite case, the voltage, which is applied to the reflective pixel electrode 192 increases. Thus in an embodiment the voltage ranges in the first transmissive region Tnm and the first reflecting region Rnm may be the same or different from each other.

In an embodiment, external light is incident on the first reflective region Rnm, passes through the liquid crystal layer, is reflected on the reflective pixel electrode 192, and passes through the liquid crystal layer again. That is, the external light passes through the liquid crystal layer twice. In an embodiment, light is incident on the first transmissive region Tnm from a backlight, transmits through the transparent electrode, and passes through the liquid crystal layer once. In this way, an image is displayed. Thus, a change in polarization of the light, which passes through the liquid crystal layer twice in the first reflective region Rnm, is allowed to be the same as a change in polarization of the light, which passes through the liquid crystal layer once in the first transmissive region Tnm, thereby making display luminance of the light transmitted through the polarizer the same. For this purpose, different voltages may be applied to the reflective pixel electrode 192 and the transparent pixel electrode 191. Alternatively, a cell gap, which can be a thickness of the liquid crystal layer, in the first reflective region Rnm may be smaller than a cell gap in the first transmissive region Tnm. The cell gap in the first reflective region Rnm can be approximately half of the cell gap in the first transmissive region Tnm. In an embodiment, the voltage, which is applied to the second pixel electrode 192, is preferably changed.

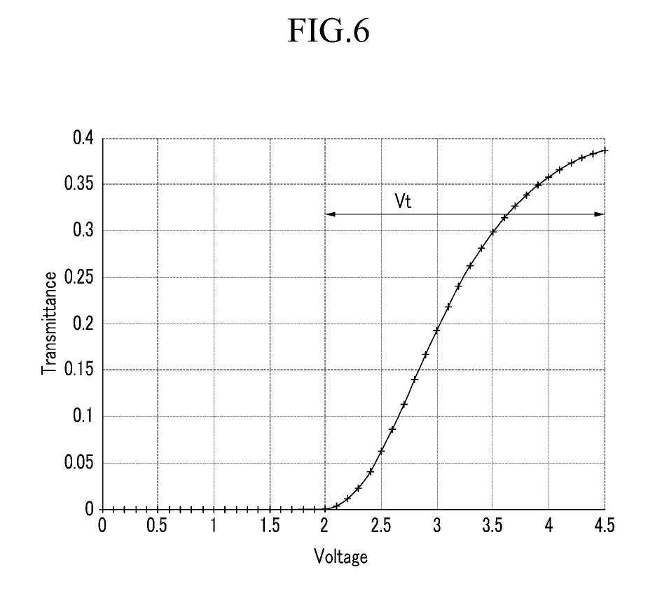

On the basis of the foregoing description, the graphs shown in FIGS. 6 to 8 are described.

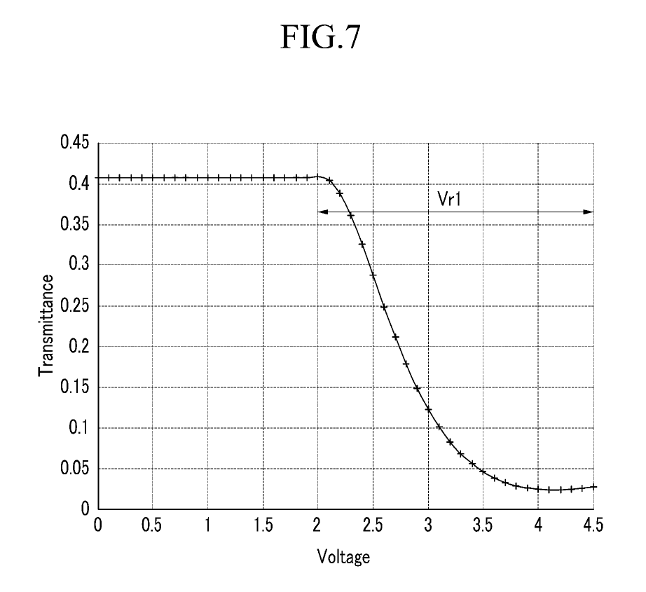

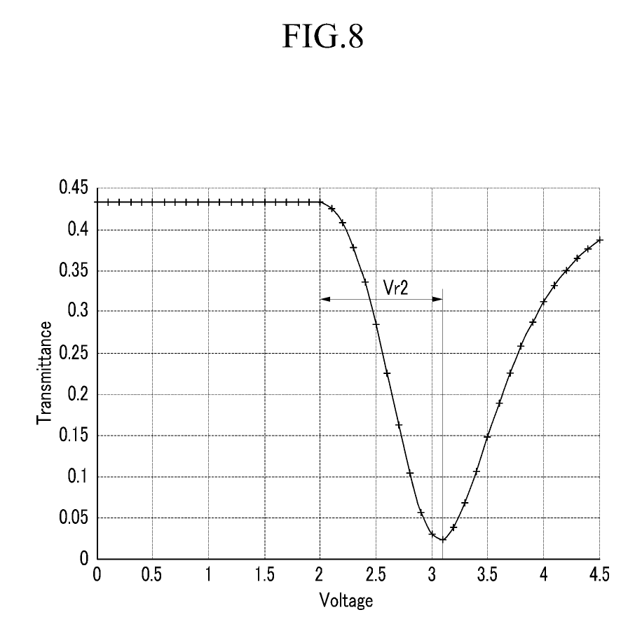

FIG. 6 is a graph illustrating transmittance with respect to a voltage in an exemplary embodiment of a transmissive region, FIG. 7 is a graph illustrating transmittance with respect to a voltage in an exemplary embodiment of a reflective region, and FIG. 8 is a graph illustrating transmittance with respect to a voltage in an exemplary embodiment a reflective region in accordance with another exemplary embodiment.

The graphs shown in FIGS. 6 and 7 may correspond to a transmissive region and a reflective region, respectively, and a transflective liquid crystal display may comprise the transmissive region and the reflective region. The graphs shown in FIGS. 6 and 8 describe another embodiment of a transflective liquid crystal display. Specifically, FIG. 8 shows an exemplary embodiment comprising constant cell gaps and different voltages applied to the reflective pixel electrode 192 and the transparent pixel electrode 191. FIG. 7 shows an exemplary embodiment in which a cell gap is reduced. FIGS. 6 and 8 show an exemplary embodiment in which a size of a cell gap is about 4.3 micrometers (“μm”), and FIG. 7 shows an exemplary embodiment in which a size of a cell gap is about 2.3 μm.

First, the exemplary embodiment shown in FIGS. 6 and 7 is described.

As shown in FIG. 6, in the first transmissive region Tnm, when a voltage increases, transmittance also increases, which improves luminance. Further, at a voltage of about 2 V or less, a transmittance, which can be a minimum transmittance, is substantially constant, and the corresponding voltage interval may not be used. In an embodiment, a voltage interval Vt, which can be between about 1 V to about 7 volts, specifically between about 2 V to about 4.5 V, more specifically between about 2.5 V to about 4 V, is a voltage range, which is desirably used in image display.

In an embodiment, in the first reflective region Rnm of FIG. 7, when a voltage increases transmittance decreases, which results in decreasing luminance. Further, at a voltage of about 2.1 V or less, specifically about 2 V or less, more specifically about 1 V or less, transmittance, which can be a maximum transmittance, is substantially constant, and thus the voltage interval may not be used. However, as in the first transmissive region Tnm, a voltage interval Vr1, which can be between about 1 V to about 7 volts, specifically between about 2 V to about 4.5 V, more specifically between about 2.5 V to about 4 V, is a voltage range which is desirably used to display an image.

In an exemplary embodiment, when a luminance is displayed, a corresponding voltage is desirably determined from the graphs shown in FIGS. 6 and 7, and applied to the transparent pixel electrode 191 and the reflective pixel electrode 192. According to the exemplary embodiment shown in FIGS. 1 to 3, a voltage, which is applied to the transparent pixel electrode 191 and the reflective pixel electrode 192, is a voltage, which is increased or decreased by the storage electrode lines S1 to Sn after the data voltage is applied to the storage electrode lines. Thus, a magnitude of the increase or decrease voltage, or the data voltage, may be selected such that the corresponding voltage is applied to the transparent and reflective pixel electrodes 191 and 192. In the exemplary embodiment shown in FIGS. 1 to 3, the cell gap of the first transmissive region Tnm is desirably larger than a cell gap of the first reflective region Rnm.

The exemplary embodiment shown in FIGS. 6 and 8 is described below.

As shown in FIG. 6, in the first transmissive region Tnm, when a voltage increases, transmittance also increases, which improves luminance. Further, at a voltage of about 2V or less, transmittance, which can be a minimum transmittance, is substantially constant, and thus the voltage interval may not be used. A voltage interval Vt in a range of about 1 V to 7 V, specifically about 2V to about 4.5V, more specifically about 2.5 V to about 4 V is desirably used to display an image.

Also, in the first reflective region Rnm of FIG. 8, when a voltage increases, transmittance decreases and then increases. Thus, at a voltage of about 2V or less, transmittance, which can be a maximum transmittance, is substantially constant. The luminance continuously decreases until a voltage of about 3 V. Then, the luminance increases again. Further, at a voltage of about 2 V or less, transmittance is substantially constant, and thus the voltage interval may not be used. The voltage interval Vr2 in a range of about 1 V, specifically about 2 V, more specifically about 2.1 V to a voltage reaching maximum luminance is desirably used to display an image.

In an exemplary embodiment, when a luminance is displayed, the corresponding voltage is desirably determined from transmittance-voltage relationships, such as those shown in FIGS. 6 and 8, and applied to the transparent pixel electrode 191 and the reflective pixel electrode 192. According to the exemplary embodiment shown in FIGS. 1 to 3, the voltage, which is applied to the transparent pixel electrode 191 and the reflective pixel electrode 192, is a voltage, which is increased or reduced by the storage electrode lines S1 to Sn after the data voltage is applied to the storage electrode lines. Thus, the change in voltage by the storage electrode, or the data voltage, may be selected such that the corresponding voltage is applied to the transparent and reflective pixel electrodes 191 and 192. In the exemplary embodiment shown in FIGS. 1 to 3, the cell gap of the first transmissive region Tnm is substantially the same as the cell gap of the first reflective region Rnm. In an embodiment, although the cell gaps in the transmissive region and the reflective region may be the same, the cell gap in the first reflective region Rnm may be different from the cell gap in the first transmissive region Tnm by about 20 percent (“%”), specifically about 30%, more specifically about 40%, of the cell gap in the first transmissive region Tnm, in consideration of factors such as a process variability.

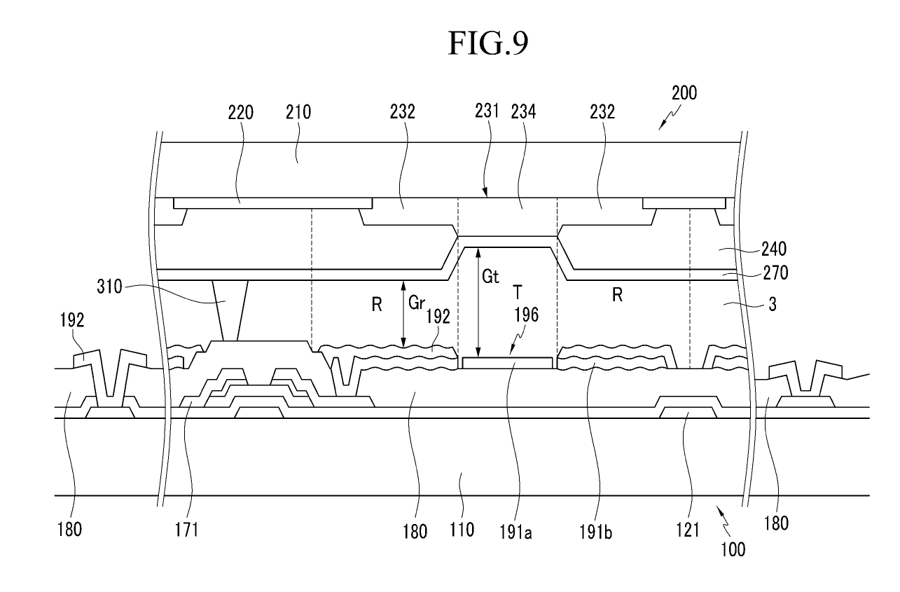

FIG. 9 shows a cross-sectional view of an exemplary embodiment of a liquid crystal display in which a cell gap in the first transmissive region Tnm is larger than a cell gap in the first reflective region Rnm.

FIG. 9 is a cross-sectional view of an exemplary embodiment of a transflective liquid crystal display.

In the exemplary embodiment shown in FIG. 9, the reflective region R has a cell gap Gr, and the transmissive region T has a cell gap Gt.

The cross-sectional view shown in FIG. 9 is described below.

A transflective liquid crystal display, according to an exemplary embodiment, includes lower and upper panels 100 and 200, respectively, wherein the lower panel 100 can be a thin film transistor array panel, and the upper panel 200 can be a color filter array panel, and the lower and upper panels are disposed opposite to each other. The transflective liquid crystal display further includes a substrate spacer 310, which constantly maintains a gap between the lower and upper panels 100 and 200, and a liquid crystal layer 3, which is interposed between the lower and upper panels 100 and 200. The substrate spacer 310 can comprise an organic insulating material, or the like, and can be disposed using a photolithography process.

In the lower display panel 100, gate lines 121 and data lines 171, which define the unit pixel areas, are disposed substantially perpendicular to each other in a matrix. Each of the pixel areas includes a thin film transistor (“TFT”). The TFTs are electrically connected to gate lines 121 and a data lines 171, and pixel electrodes, which are electrically connected to the TFTs. The pixel electrodes include transparent pixel electrode 191, which can comprise a transparent conductive layer, and a reflective pixel electrode 192, which can comprise a conductive layer having a selected reflectivity wherein an embossing process is performed on a surface thereof and the transparent pixel electrode has a transmitting window 196. The region, which is occupied by the transmitting window 196, is a transmissive region T, and the other region of the pixel area is a reflective region R. The transparent pixel electrode 191 comprises a first portion 191a disposed under the transmitting window 196 and electrically separated from a second portion 191b of the transparent pixel electrode 191, which is disposed below the reflective electrode 192.

In the upper panel 200, which is disposed opposite to the lower panel 100, a black matrix 220, which has openings corresponding to the pixel areas, is disposed. In each pixel area, red, green, and blue color filters 231 can be disposed. Each of the red, green, and blue color filters 231 can include first and second portions 232 and 234, having different thicknesses according to the display areas R and T, respectively. In an embodiment, the second portion 234, corresponding to the transmissive region T, is thicker than the first portion 232. The color filter 231 is covered by an upper passivation layer 240, which comprises an organic insulating material, or the like, and a common electrode is disposed on the upper passivation layer 240. The upper passivation layer 240 is disposed to have different thicknesses according to the display areas R and T. In an exemplary embodiment, in a portion which corresponds to the transmissive region T, the upper passivation layer 240 is removed.

The reflective region R can be used to display an image using light reflected on the second pixel electrode 192, which is reflective, and the transmissive region T can be used to display an image using light emitted from a backlight, which is a light source.

In a liquid crystal display according to the exemplary embodiment shown in FIG. 9, in the transmissive region T, light emitted from the backlight passes through the liquid crystal layer, passes through the color filter 234 once, and is displayed as an image. In the reflective region R, light for displaying an image passes through the color filter 232 when the light reaches the reflecting electrode from the outside, is reflected on the second pixel electrode 192, and passes through the color filter 232 again. In consideration of the luminance characteristics of the reflective region R, the thickness of the color filter 232 in the reflective region R is smaller than the thickness of the color filter 234 in the transmissive region T. In this way, a uniformity of light for displaying an image, which passes through the color filter 231 in the individual mode regions T and R, can be improved. As a result, a uniformity of color reproducibility can be improved in the two display mode regions T and R, which results in improving a display characteristic of the liquid crystal display.

Alternatively, a thickness of the color filter 231 may be the same in the reflective region R and the transmissive region T.

In the exemplary embodiment shown in FIG. 9, in order to select the cell gaps in the reflective region R and the transmissive region T, the upper passivation layer 240 is disposed to have different thicknesses in the individual regions T and R. Alternatively, the cell gaps in the individual regions T and R can be selected by selecting the thickness of the passivation layer 180 of the lower substrate.

In an embodiment, the color filter 230 is disposed on an upper substrate 210. The color filter 230 may be disposed on a lower substrate 110. When the color filter is disposed on the lower substrate 110, the color filter may be disposed on the passivation layer 180 and below the transparent pixel electrode 191 and the reflective pixel electrode 192. Further, the color filter 230 may be disposed at a location where the passivation layer 180 is disposed, instead of the passivation layer 180.

A transflective liquid crystal display has been described in which a data voltage is applied to the reflective pixel electrode 192 and the transparent pixel electrode 191 on the basis of FIGS. 1 to 3, and the reflective pixel electrode 192 and the transparent pixel electrode 191 have different final voltages by increasing or reducing the data voltage.

Hereinafter, another exemplary embodiment is described in which two data lines and two thin film transistors are disposed in each pixel, the reflective pixel electrode 192 and the transparent pixel electrode 191 are electrically connected to each pixel, and different data voltages are first applied to the reflective pixel electrode 192 and the transparent pixel electrode 191.

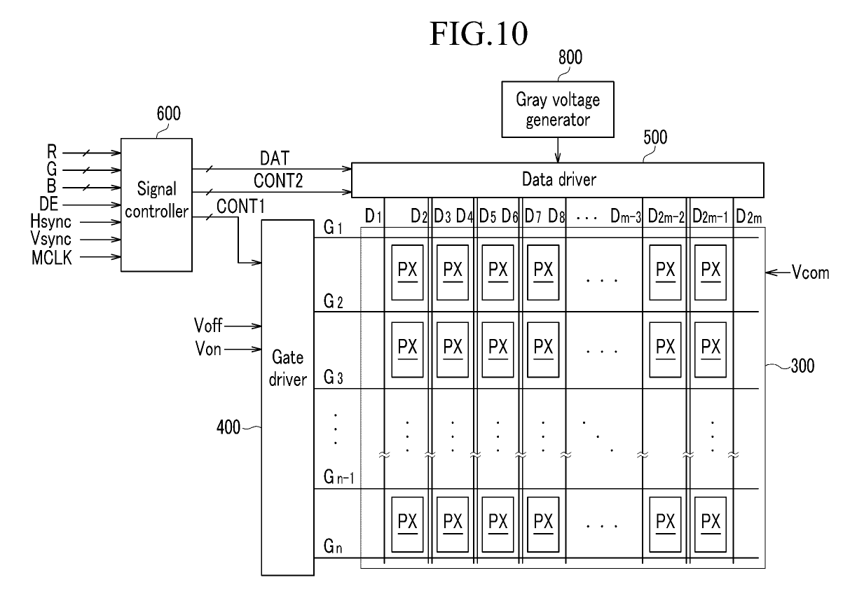

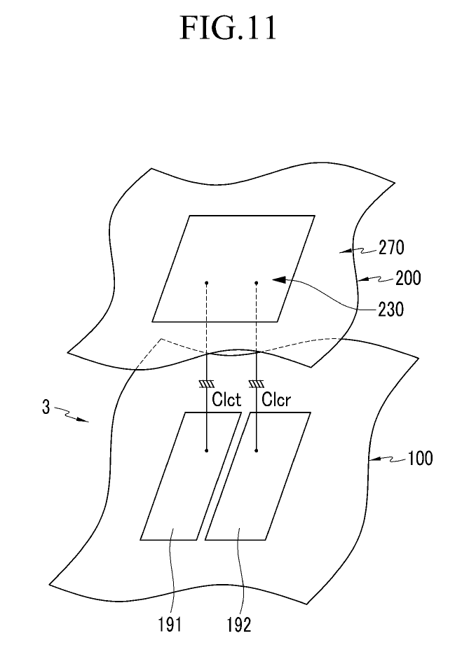

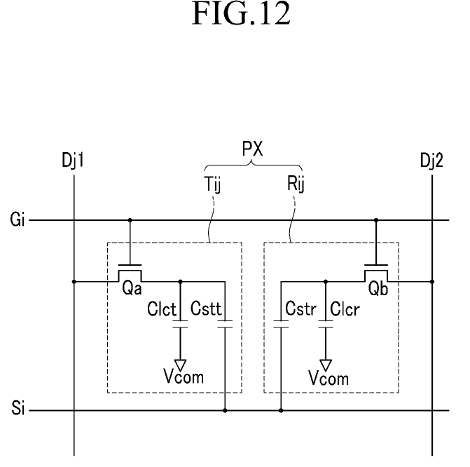

FIG. 10 is a block diagram of an exemplary embodiment of a liquid crystal display, and FIG. 11 is an equivalent circuit diagram of an exemplary embodiment of a pixel in an exemplary embodiment of a liquid crystal display.

As shown in FIG. 10, the liquid crystal display according to the exemplary embodiment includes a liquid crystal panel assembly 300. The liquid crystal display includes a gate driver 400 and a data driver 500 electrically connected to the liquid crystal panel assembly 300, a gray voltage generator 800 electrically connected to the data driver 500, and a signal controller 600 for controlling and electrically connected to the above-described components.

In the equivalent circuit diagram, the liquid crystal panel assembly 300 includes a plurality of display signal lines, including gate lines G1 to Gn and data lines D1 to D2m, and a plurality of pixels PX, which are electrically connected to the plurality of display signal lines, including gate lines G1 to Gn and data lines D1 to D2m, and are substantially arranged in a matrix. As seen from the structure shown in FIG. 11, the liquid crystal panel assembly 300 includes lower and upper panels 100 and 200, which are disposed opposite to each other, and a liquid crystal layer 3 interposed therebetween.

The display signal lines include a plurality of gate lines G1 to Gn, which transmit gate signals, also referred to as scanning signals, and a plurality of data lines D1 to D2m, which transmit data signals. The gate lines G1 to Gn substantially extend in a row direction so as to be parallel to each other. The data lines D1 to D2m substantially extend in a column direction so as to be parallel to each other. A pair of data lines D1 to D2m are disposed between any two adjacent pixels PX.

Each of the pixels PX includes a transmissive region Tij and a reflective region Rij, as shown in FIG. 12. The individual regions Tij and Rij include switching elements (not shown), which are electrically connected to signal lines, and transmissive and reflective liquid crystal capacitors Clct and Clcr and storage capacitors (not shown), which are electrically connected to the switching elements. The storage capacitors may be omitted, if desirable.

Each switching element is a three-terminal element, such as a thin film transistor, or the like, which is disposed in the lower panel 100. A control terminal of the switching element is electrically connected to the gate line GL, an input terminal thereof is electrically connected to the data line DL, and an output terminal thereof is electrically connected to the transmissive and reflective liquid crystal capacitor Clct and Clcr and the storage capacitor.

The storage capacitor, which assists the transmissive and reflective liquid crystal capacitors Clct and Clcr, is disposed by overlapping a separate signal line (not shown) and the transparent pixel electrode 191 disposed on the lower panel 100, with an insulator interposed therebetween. A selected voltage, such as the common voltage Vcom, is applied to the separate signal line.

In an embodiment, in order to implement color display, each of the pixels PX displays one of primary colors (spatial division), or displays the primary colors with the passage of time (temporal division), which causes the desired colors to be displayed by spatial and temporal sums of the primary colors. Exemplary primary colors include the primary colors red, green, and blue. Shown in FIG. 11 is an exemplary embodiment of spatial division, which illustrates an embodiment in which each of the pixels PX has a color filter 230 for displaying one of the primary colors in regions of the upper panel 200, which correspond to the transparent and reflective pixel electrodes 191 and 192. Unlike FIG. 11, the color filter 230 may be disposed above or below the transparent and reflective pixel electrodes 191 and 192 of the lower panel 100.

Polarizers (not shown) can be disposed on outer surfaces of the lower and upper panels 100 and 200. The polarization axes of the polarizers may be orthogonal to each other. In an embodiment comprising a reflective liquid crystal display, one of the polarizers may be omitted. In an embodiment comprising crossed polarizers, incident light, which enters into the liquid crystal layer 3 having no electric field, is blocked.

Referring to FIG. 10 again, the gray voltage generator 800 can generate two gray voltage groups, or reference gray voltage groups, corresponding to the transmittance of each of the pixels PX. One of the two gray voltage groups has a positive value with respect to the common voltage Vcom, and the other has a negative value with respect to the common voltage Vcom.

The gate driver 400 is electrically connected to the gate lines of the liquid crystal panel assembly 300, and applies gate signals Vg, each comprising a combination of a gate-on voltage Von and a gate-off voltage Voff, to the gate lines.

The data driver 500 is electrically connected to the data lines D1 to D2m of the liquid crystal panel assembly 300, selects the gray voltages from the gray voltage generator 800, and applies the selected gray voltages to the data lines D1 to D2m as the data signals. In an embodiment, when the gray voltage generator 800 provides only a selected number of reference gray voltages, the data driver 500 divides the reference gray voltages to generate gray voltages with respect to all grays and selects a data signal from the gray voltages.

The signal controller 600 controls the gate driver 400 and the data driver 500.

Each of the driving devices, including the gate driver 400, the data driver 500, the signal controller 600, and the gray voltage generator 800 may be directly mounted on the liquid crystal panel assembly 300 in a form of one or more IC chips, mounted on a flexible printed circuit film (not shown) to be disposed on the liquid crystal panel assembly 300 in a form of a TCP, or mounted on a separate printed circuit board (not shown). Alternatively, the driving devices may be integrated with the liquid crystal panel assembly 300. In addition, the driving devices may be integrated into a single chip. In an embodiment, at least one of the driving devices, or at least one circuit element, which constitute one or more of the driving devices may be disposed outside the single chip.

The structure of the liquid crystal panel assembly is described in detail with reference to FIG. 12 and FIGS. 10 and 11.

FIG. 12 is an equivalent circuit diagram of an exemplary embodiment of a pixel in an exemplary embodiment a liquid crystal display.

Referring to FIG. 12, the liquid crystal panel assembly includes signal lines, which include a gate line Gi, a pairs of data lines Dj1 and Dj2, and a storage electrode line Si, and a plurality of pixels PX, which are electrically connected to the signal lines.

Each of the pixels PX includes a transmissive region Tij and a reflective region Rij. The transmissive and reflective regions Tij and Rij include transmissive and reflective switching elements Qa and Qb, respectively, which are electrically connected to a corresponding gate line Gi and corresponding data lines Dj1 and Dj2, transmissive and reflective liquid crystal capacitors Clct and Clcr, which are electrically connected to the transmissive and reflective switching elements Qa and Qb, respectively, and transmissive and reflective storage capacitors Cstt and Cstr, which are electrically connected to the transmissive and reflective switching elements Qa and Qb, respectively, and the second storage electrode line Si.

Each of the transmissive and reflective switching elements Qa and Qb is a three-terminal element, such as a thin film transistor, which is disposed on the lower panel 100. A control terminal of each transmissive and reflective switching element Qa and Qb is electrically connected to the gate line Gi1 an input terminal thereof is electrically connected to the data lines Dj1 and Dj2, and an output terminal thereof is electrically connected to transmissive and reflective liquid crystal capacitors Clct and Clcr and the transmissive and reflective storage capacitors Cstt and Cstr, respectively.

The transmissive and reflective storage capacitors Cstt and Cstr, which assist the transmissive and reflective liquid crystal capacitors Clct and Clcr, are disposed by overlapping a respective second storage electrode line Si and the pixel electrodes PX disposed in the lower panel 100 with an insulator interposed therebetween. A selected voltage, such as the common voltage Vcom, is applied to the second storage electrode line Si.

Since the transmissive and reflective liquid crystal capacitors Clct and Clcr are already described above, the detailed description thereof will be omitted.

In the liquid crystal display including the liquid crystal panel assembly, the signal controller 600 may receive input image signals R, G, and B for each pixel, convert the input signals into output image signals DAT for the transmissive and reflective regions Tij and Rij, and transmit the converted output image signals to the data driver 500. Alternatively, a gray voltage group of each of the transmissive and reflective regions Tij and Rij can be separately formed by the gray voltage generator 800 so as to be alternately supplied to the data driver 500, or the data driver 500 can alternately select the gray voltage groups for the transmissive and reflective regions Tij and Rij so as to apply different voltages to the transmissive and reflective regions Tij and Rij.

In an embodiment, the voltages, which are applied to the transmissive and reflective regions Tij and Rij, are the same as the voltages described in the description of FIGS. 6 to 8. Thus when the cell gap in the reflective region Rij is the same as the cell gap in the transmissive region Tij, using a curved line of transmittance with respect to voltage, as shown in FIGS. 6 and 7, a data voltage may be selected for application to the transparent and reflective pixel electrodes 191 and 192. When the cell gap in the reflective region Rij is smaller than the cell gap in the transmissive region Tij, using a curved line of the transmittance with respect to voltage, as shown in FIGS. 6 and 8, a data voltage may be selected for application to the transparent and reflective pixel electrodes 191 and 192. In the exemplary embodiment shown in FIGS. 1 to 3, the data voltage and an amount of voltage increase or decrease are desirably considered when a voltage is applied to the transparent and reflective pixel electrodes 191 and 192 using the transmittance-voltage relationship shown in the graphs of FIGS. 6 to 8. However, in the exemplary embodiment shown in FIGS. 10 to 12, different data voltages are applied through the different data lines. The voltage corresponding to the desired luminance may be applied to the transparent pixel electrode 191 and the reflective pixel electrode 192.

FIGS. 10 to 12 show a structure where two data lines are disposed for each pixel. In accordance with the exemplary embodiment, three or more data lines may be disposed.

The structure of the exemplary embodiment shown in FIGS. 1 to 3 is different from the structure of the exemplary embodiment shown in FIGS. 10 to 12. In another exemplary embodiment, different voltages, which satisfy selected conditions, are applied to the regions T and R without using a phase difference film and a transflective liquid crystal display is formed.

Further, the disclosed embodiments may be applied to a display device using a horizontal electric field. In the display device using the horizontal electric field, a transparent electrode, a reflecting electrode, and a common electrode are disposed on one substrate. Further, at least one of the transparent electrode, the reflecting electrode, and the common electrode can have two or more linear electrodes in each pixel area, and each of the transparent electrode, the reflecting electrode, and the common electrode may have two or more linear electrodes in each pixel area.

While this invention has been described in connection with exemplary embodiments, it is to be understood that the invention is not limited to the disclosed embodiments, but, on the contrary, is intended to cover various modifications and equivalent arrangements included within the spirit and scope of the appended claims. Thus it will be understood by those skilled in the art that various changes can be made and equivalents can be substituted for elements thereof without departing from the scope of the disclosed embodiments. In addition, many modifications can be made to adapt a particular situation or material to the teachings of this disclosure without departing from the essential scope thereof.

What is claimed is:

1. A display device, comprising:
a lower substrate;
an upper substrate disposed opposite to the lower substrate;
a liquid crystal layer interposed between the lower substrate and the upper substrate; and
a plurality of pixels, each of the pixels comprising at least one reflective electrode and at least one transparent electrode;
the reflective electrodes and the transparent electrodes disposed on the lower substrate and electrically insulated from each other,
wherein a reflective region corresponds to a region of the reflective electrodes and a transmissive region corresponds to a region of the transparent electrodes, and
when a display luminance in the reflective region and the transmissive region is increased, a first voltage applied to the liquid crystal layer in one of the reflective region and the transmissive region is increased and a second voltage applied to the liquid crystal layer in the other of the reflective region and the transmissive region is decreased.

2. The display device of claim 1, wherein
when a white color is displayed in the reflective region, a white color is displayed in the transmissive region, and when a black color is displayed in the reflective region, a black color is displayed in the transmissive region.

3. The display device of claim 1, wherein
when the display luminance is increased, a first voltage applied to the liquid crystal layer in the transmissive region is increased, and a second voltage applied to the liquid crystal layer in the reflective region is decreased.

4. The display device of claim 1, further comprising
first signal lines disposed on the lower substrate and crossing regions between the reflecting electrodes and the transparent electrodes;
second signal lines disposed on the lower substrate substantially parallel to gate lines and crossing regions between adjacent pixels in a vertical direction;
data lines disposed on the lower substrate and crossing the first signal lines and the second signal lines, the data lines, the first signal lines, and the second signal lines electrically insulated from each other;
first thin film transistors electrically connected to the transparent electrodes; and
second thin film transistors electrically connected to the reflecting electrodes,
wherein one of the first signal lines and the second signal lines are the gate lines and the other of the first signal lines and the second signal lines are storage electrode lines,
adjacent first and second thin film transistors are electrically connected to a same gate line and a same data line, and
the storage electrode lines overlap the reflecting electrodes of adjacent pixels and the transparent electrodes of other pixels.

5. The display device of claim 4, wherein a plurality of voltages are sequentially applied to the storage electrode lines in one direction such that a high voltage and a low voltage are alternately applied to the storage electrode lines, the high voltage being greater than the low voltage.

6. The display device of claim 5, wherein
the high voltage or the low voltage applied to the storage electrode lines is changed to a gate-off signal, wherein the high voltage or the low voltage is applied after a gate signal is applied to thin film transistors electrically connected to the storage electrode lines.

7. The display device of claim 6, wherein
an area where the storage electrode lines and the reflective electrodes overlap is different from an area where the storage electrode lines and the transparent electrodes overlap.

8. The display device of claim 7, wherein
an area where the storage electrode lines and the transparent electrodes overlap is equal to or larger than an area where the storage electrode lines and the reflective electrodes overlap.

9. The display device of claim 4, wherein
a kick-back voltage is selected by selecting a parasitic capacity of the reflective region and a parasitic capacity of the transmissive region.

10. The display device of claim 1, further comprising:
gate lines disposed on the lower substrate;
data lines disposed on the lower substrate and crossing the gate lines, wherein the data lines and gate lines are electrically insulated from each other;
first thin film transistors electrically connected to the transparent electrodes; and
second thin film transistors electrically connected to the reflecting electrodes,
wherein the first and second thin film transistors are disposed in a pixel and are electrically connected to the same gate line and different data lines.

11. The display device of claim 10, wherein
two or more data lines are disposed for each pixel.

12. The display device of claim 1, wherein
a range of voltages applied to the reflecting electrodes is the same as a range of voltages applied to the transparent electrodes.

13. The display device of claim 12, wherein
a thickness of the liquid crystal layer disposed in the reflective region is less than a thickness of the liquid crystal layer disposed in the transmissive region.

14. The display device of claim 12, further comprising
color filters disposed on the upper and lower substrates of the display device,
wherein a thickness of the color filter in the reflective region is less than a thickness of the color filter in the transmissive region.

15. The display device of claim 1, wherein
a range of voltages applied to the reflecting electrodes is different from a range of voltages applied to the transparent electrodes.

16. The display device of claim 15, wherein
a difference between a thickness of the liquid crystal layer disposed in the reflective region and a thickness of the liquid crystal layer disposed in the transmissive region is within about 30 percent of the thickness of the liquid crystal layer disposed in the transmissive region.

17. The display device of claim 15, further comprising
color filters disposed on at least one of the upper substrate and the lower substrate,
wherein a thickness of the color filter in the reflective region is less than a thickness of the color filter in the transmissive region.

18. The display device of claim 1, wherein
a range of voltages applied to the reflecting electrodes and the transparent electrodes is selected to include a range of voltages wherein transmittance increases or decreases when an increased or decreased voltage is sequentially applied to the reflecting electrodes and the transparent electrodes.

19. The display device of claim 1, further comprising
a common electrode disposed on one of the lower substrate and the upper substrate and applied with a common voltage.

20. The display device of claim 19, wherein
the common electrode is disposed on the lower substrate, and
at least one of the reflecting electrodes, the transparent electrodes, and the common electrode includes two or more linear electrodes in a pixel.
